(19) United States
(12) Patent Application Publication
(10) Pub. No.: US 2016/0199236 A1
(43) Pub. Date: Jul. 14, 2016

(54) RAMP ASSEMBLY

(71) Applicant: James Ford, Birmingham, AL (US)

(72) Inventor: James Ford, Birmingham, AL (US)

(21) Appl. No.: 14/592,909

(22) Filed: Jan. 9, 2015

(51) Int. Cl. A61G 3/06; B60P 1/43

(52) U.S. Cl. CPC A61G 3/061; B60P 1/43

(57) ABSTRACT

A ramp assembly includes a pair of ramps each that has a top surface, a bottom surface and a peripheral edge extending therebetween. Each of the ramps may be positioned to define an inclined plane between two surfaces. A powered wheel chair may be driven upwardly and downwardly along the ramps. A pair of lateral walls is coupled to the ramps. A roller is coupled to each of the ramps. The roller is positioned to be engaged by tires of the powered wheel chair when the powered wheel chair is driven on the ramps. The roller prevents the powered wheel chair from climbing the lateral wall and tipping from the ramps.

### BACKGROUND OF THE DISCLOSURE

### Field of the Disclosure

The disclosure relates to ramp devices and more particularly pertains to a new ramp device for allowing a powered wheel chair to drive on the ramp without tipping off of the ramp.

### SUMMARY OF THE DISCLOSURE

An embodiment of the disclosure meets the needs presented above by generally comprising a pair of ramps that each has a top surface, a bottom surface and a peripheral edge extending therebetween. Each of the ramps may be positioned to define an inclined plane between two surfaces. A powered wheel chair may be driven upwardly and downwardly along the ramps. A pair of lateral walls is coupled to the ramps. A roller is coupled to each of the ramps. The roller is positioned to be engaged by tires of the powered wheel chair when the powered wheel chair is driven on the ramps. The roller prevents the powered wheel chair from climbing the lateral wall and tipping from the ramps.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an in-use view of a ramp assembly according to an embodiment of the disclosure.

FIG. 2 is a top view of an embodiment of the disclosure.

FIG. 3 is a right side view of an embodiment of the disclosure.

FIG. 4 is a cross sectional view taken along line 4-4 of figure of an embodiment of the disclosure.

FIG. 5 is a left side view of an embodiment of the disclosure in a stored position.

### DESCRIPTION OF THE PREFERRED EMBODIMENT

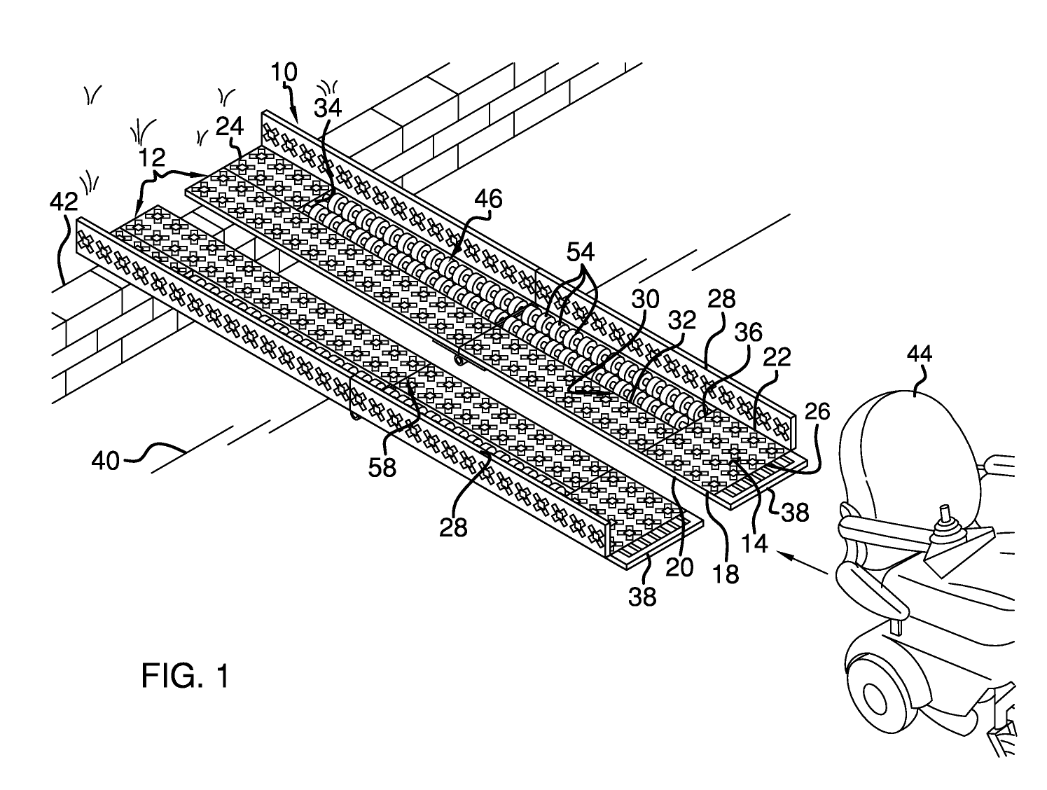

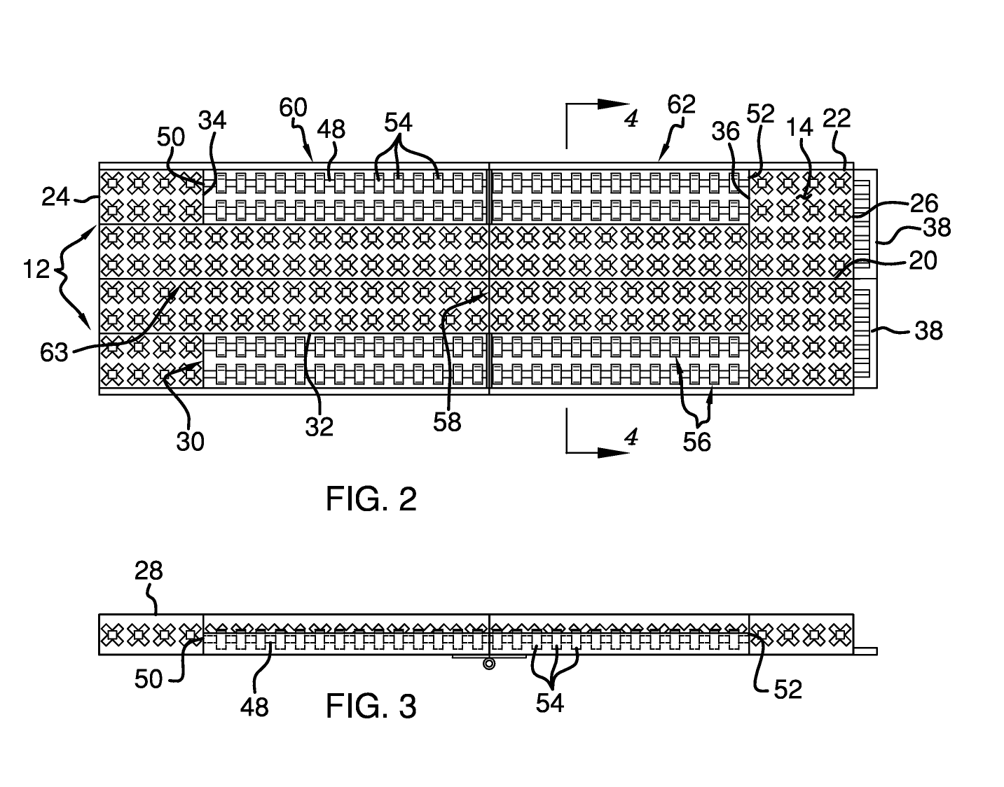

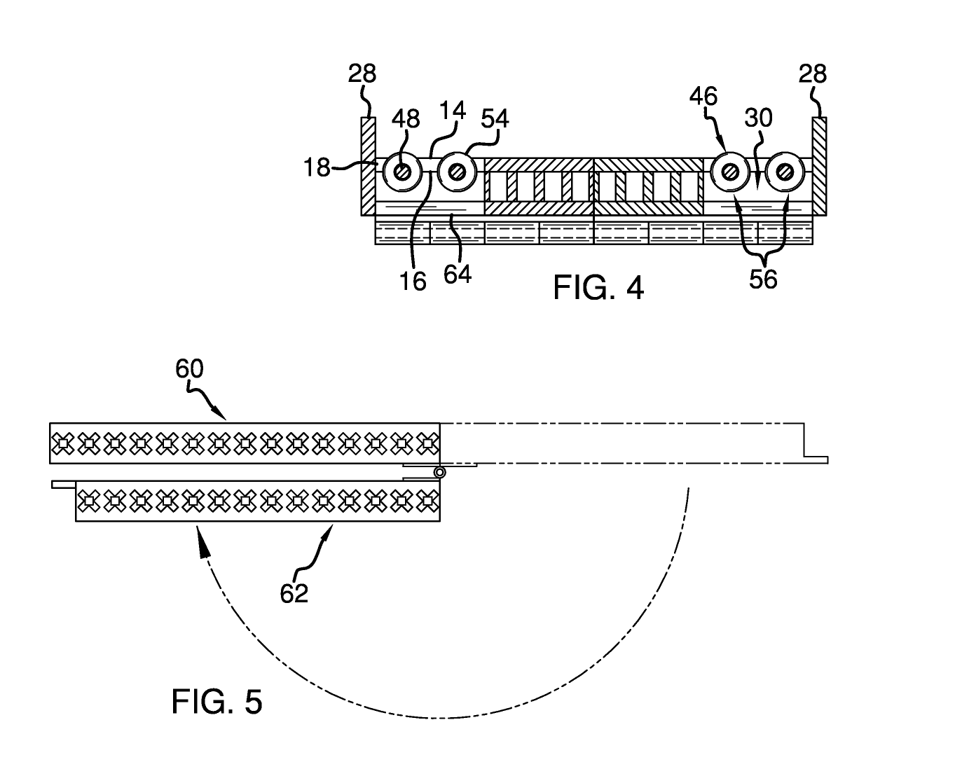

With reference now to the drawings, and in particular to FIGS. 1 through 5 thereof, a new ramp device embodying the principles and concepts of an embodiment of the disclosure and generally designated by the reference numeral 10 will be described.

As best illustrated in FIGS. 1 through 5, the ramp assembly 10 generally comprises a pair of ramps 12 that each has a top surface 14, a bottom surface 16 and a peripheral edge 18 extending therebetween. The peripheral edge 18 has an inner side 20 and an outer side 22. Each of the ramps 12 is elongated between a front side 24 and a back side 26 of the peripheral edge 18. A pair of lateral walls 28 is provided. Each outer side 22 has one of the lateral walls 28 coupled thereto and extending upwardly therefrom. Each of the ramps 12 may be perforated between the top 14 and bottom 16 surfaces. Additionally, the top surface 14 of each of the ramps 12 may be textured to provide grip.

Each of the ramps 12 has a slot 30 extending through the top surface 14 and the bottom surface 16. The slots 30 extend substantially between the front side 24 and the back side 26. A bounding surface 32 of each of the slots 30 has a first side 34 and a second side 36. The slot 30 is positioned adjacent to the lateral wall 28. A lip 38 is coupled to the back side 26 of each of the ramps 12.

Each of the ramps 12 may be positioned to define an inclined plane between ground 40 and an elevated surface 42 with respect to ground 40. The lip 38 may abut ground 40. A powered wheel chair 44 may be driven upwardly and downwardly along the ramps 12. The powered wheel chair 44 may be of any conventional design. The elevated surface 42 may be a step, a retaining wall or other elevated surface 42 with respect to ground 40.

Each of the ramps 12 includes a roller 46. The roller 46 is positioned to be engaged by tires 46 of the powered wheel chair 44 when the powered wheel chair 44 is driven on the ramps 12. The roller 46 prevents the powered wheel chair 44 from climbing the lateral wall 28 and tipping from the ramps 12. The powered wheel chair 44 may be driven forwardly or rearwardly along the ramps 12. The roller 46 comprises a shaft 48 that has a first end 50 and a second end 52. The shaft 48 is positioned within the slot 30 in each of the ramps 12. The first end 50 is coupled to the first side 34. The second end 52 is coupled to the second side 36. A plurality of wheels 54 is rotationally coupled to the shaft 48. The wheels 54 are distributed along between the first end 50 and the second end 52.

The wheels 54 are oriented to have a rotational axis extending between the front side 24 and the back side 26 of the peripheral edge 18. The tires 46 roll along the wheels 54 when the powered wheel chair 44 is driven on the ramps 12. The wheels 54 guide the tires 46 toward a center of the ramps 12 to keep the powered wheel chair 44 centered on the ramps 12. The roller 46 may be one of a pair of rollers 56 coupled to each of the ramps 12.

Each of the ramps 12 may have a break 58 therein to define a first section 60 hingedly coupled to a second section 62. The first 60 and second 62 sections may be positionable in a stored position such that the bottom surface 16 of the first 60 and second 62 sections faces each other. The first 60 and second 62 sections may be positionable in a deployed position to extend between ground 40 and the elevated surface 42.

The ramps 12 may be a single ramp 12. The lateral walls 28 are spaced apart from each other and positioned on the outer sides 22 of the single ramp 12. The rollers 56 may be spaced apart from a center 63 of the single ramp 12 and positioned adjacent to one of the lateral walls 28.

A pair of lower walls 64 may be provided. Each of the lower walls 64 may be coupled to one of the ramps 12. The lower walls 64 may be spaced downwarldy from the bottom surface 16 of the ramps 12. Additionally, the lower walls 64 may be coextensive with the ramps 12. The lower walls 64 may abut ground 40 to prevent the wheels 54 from engaging ground 40.

In use, the ramps 12 are position between ground 40 and the elevated surface 42 when the powered wheel chair 44 needs to access the elevated surface 42. The roller 46 prevents the powered wheel chair 44 from driving sideways off of the ramps 12 and causing an injury. The ramps 12 are positioned in the stored position when the ramps 12 are not in use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ramp assembly configured to allow a powered wheel chair to traverse an incline, said assembly comprising:
a pair of ramps each having a top surface, a bottom surface and a peripheral edge extending therebetween, each of said ramps being configured to be positioned to define an inclined plane between ground and an elevated surface thereby configured to facilitate a powered wheel chair to be driven upwardly and downwardly along said ramps;
a pair of lateral walls coupled to said ramps; and
a roller coupled to each of said ramps, said roller being positioned to be engaged by tires of the powered wheel chair when the powered wheel chair is driven on said ramps thereby preventing the powered wheel chair from climbing said lateral wall and tipping from said ramps.

2. The assembly according to claim 1, wherein said peripheral edge has an inner side and an outer side, each of said ramps being elongated between a front side and a back side of said peripheral edge.

3. The assembly according to claim 2, further including a pair of lateral walls, each outer side having one of said lateral walls being coupled thereto and extending upwardly therefrom.

4. The assembly according to claim 3, wherein each of said ramps has a slot extending through said top surface and said bottom surface, said slots extending substantially between said front side and said back side, a bounding surface of each of said slots having a first side and a second side, said slot being positioned adjacent to said lateral wall, said roller being positioned within said slot.

5. The assembly according to claim 4, wherein said roller comprises a shaft having a first end and a second end, said shaft being positioned within said slot in each of said ramps, said first end being coupled to said first side, said second end being coupled to said second side.

6. The assembly according to claim 5, wherein a plurality of wheels rotationally coupled to said shaft, said wheels being distributed along between said first end and said second end, said wheels being oriented to have a rotational axis extending between said front side and said back side of said peripheral edge, said tires rolling along said wheels when the powered wheel chair is driven on said ramps such that said wheels guide the tires toward a center of said ramps

7. A ramp assembly configured to allow a powered wheel chair to traverse an incline, said assembly comprising:
a pair of ramps each having a top surface, a bottom surface and a peripheral edge extending therebetween, said peripheral edge having an inner side and an outer side, each of said ramps being elongated between a front side and a back side of said peripheral edge;
a pair of lateral walls, each outer side having one of said lateral walls being coupled thereto and extending upwardly therefrom;
each of said ramps having a slot extending through said top surface and said bottom surface, said slots extending substantially between said front side and said back side, a bounding surface of each of said slots having a first side and a second side, said slot being positioned adjacent to said lateral wall;
each of said ramps being configured to be positioned to define an inclined plane between ground and an elevated surface thereby facilitating a powered wheel chair to be driven upwardly and downwardly along said ramps;
each of said ramps including:
a roller coupled to each of said ramps, said roller being positioned to be engaged by tires of the powered wheel chair when the powered wheel chair is driven on said ramps thereby preventing the powered wheel chair from climbing said lateral wall and tipping from said ramps, said roller comprising:
a shaft having a first end and a second end, said shaft being positioned within said slot in each of said ramps, said first end being coupled to said first side, said second end being coupled to said second side; and
a plurality of wheels rotationally coupled to said shaft, said wheels being distributed along between said first end and said second end, said wheels being oriented to have a rotational axis extending between said front side and said back side of said peripheral edge, the tires rolling along said wheels when the powered wheel chair is driven on said ramps such that said wheels guide the tires toward a center of said ramps.
